(19) United States
(12) Patent Application Publication
(10) Pub. No.: US 2006/0119606 A1
(43) Pub. Date: Jun. 8, 2006

(54) Information processing apparatus, information processing method, recording medium and program

(75) Inventors: Motohiro Nishihata, Kanagawa (JP); Yuichi Nishimori, Chiba (JP); Satoshi Shinohara, Tokyo (JP)

Correspondence Address: WOLF GREENFIELD & SACKS, PC;FEDERAL RESERVE PLAZA, 600 ATLANTIC AVENUE, BOSTON, MA, 02210-2206, US

(73) Assignee: Sony Corporation, Tokyo (JP)

(21) Appl. No.: 11/289,123

(22) Filed: Nov. 29, 2005

(30) Foreign Application Priority Data
Nov. 29, 2004 (JP) P2004-344184

(51) Int. Cl. G09G 5/36

(52) U.S. Cl. 345/545

(57) ABSTRACT

According to the present invention, in retrieving image data recorded in a recording medium and implementing successive effect displaying of plural images corresponding to the retrieved image data, the effect displaying is allowed with as less displaying memory as possible.

### CROSS REFERENCES TO RELATED APPLICATIONS

The present invention contains subject matter related to Japanese Patent Application JP 2004-344184 filed in the Japanese Patent Office on Nov. 29, 2004, the entire contents of which being incorporated herein by reference.

### BACKGROUND OF THE INVENTION

The present invention relates to information processing apparatus, information processing methods, recording media and programs, and particularly to an information processing apparatus, an information processing method, a recording medium and a program that each allow images to be displayed successively in a random manner with a simplified configuration.

One of image effects used in displaying images recorded in a recording medium is an effect referred to as push-in, by which an image looks to emerge as if it pushed the previous image out. In the displaying by use of the push-in effect (hereinafter referred to as push-in displaying), the direction in which images look to be pushed out will be referred to as an effect direction hereinafter.

FIGS. 1A to 1C illustrate maps in a video random access memory (VRAM) when implementing push-in displaying with its effect direction being the upward direction. In the example of FIGS. 1A to 1C, maps in the VRAM (hereinafter, VRAM map) are illustrated in the order of movement of a display area W, i.e., in the order of FIG. 1A, FIG. 1B and FIG. 1C.

The VRAM map is composed of areas arranged along the effect direction. Specifically, the VRAM map includes, in order from the upside of the drawing, an area for one screen (hereinafter, one-screen area) starting from address 0000 and including an image a1 developed therein, a one-screen area starting from address 0800 and including an image b1 developed therein, a one-screen area starting from address 1000 and including an image c1 developed therein, a one-screen area starting from address 1800 and including an image d1 developed therein, and so forth.

In the push-in displaying with its effect direction being the upward direction, the display area W moves on the VRAM map in the downward direction. Specifically, a display beginning position, which is an address shown at the upper left of the display area W, is moved in the downward direction of the drawing, from address 0000 to address 0200 (FIG. 1A), address 0800 (FIG. 1B) and address 1000 (FIG. 1C) sequentially. In step with this movement, the display area W, which includes image data of an image to be displayed on a monitor, also moves in the downward direction of the drawing, to the area from address 0200 to the front of address 0A00 (address 09FF), the area from address 0800 to the front of address 1000 (address 0FFF), and the area from address 1000 to the front of address 1800 (address 17FF), sequentially.

Thus, images are sequentially displayed on the monitor as if the previous image was pushed out in the upward direction of the drawing, i.e., as if the image b1 gradually emerged with pushing out the image a1, and the image c1 gradually emerged with pushing out the image b1.

Therefore, the push-in displaying can be successively carried out a number of times corresponding to the number of images to be pushed out, of which image data has been developed in the VRAM areas (the number of one-screen areas in which image data of the images has been developed). That is, in order to achieve the push-in displaying, there arises a need for a VRAM that is composed of a number of areas with size for one-screen displaying corresponding to the number of movements in the effect direction. Accordingly, in order to reduce VRAM to be used, a method has been proposed in which a VRAM is provided with a ring buffer configuration and the limitation on the movement direction is avoided by address control.

When carrying out push-in displaying within the range of a VRAM composed of finite areas like that shown in FIG. 2, the limitation of the VRAM may preclude the push-in displaying in a desired direction.

The VRAM map of FIG. 2 is composed of finite areas of 3×3 (three rows by three columns) of screens. The uppermost row is composed of a one-screen area including an image a1 developed therein, a one-screen area including an image a2 developed therein and a one-screen area including an image a3 developed therein. The middle row is composed of a one-screen area including an image b1 developed therein, a one-screen area including an image b2 developed therein and a one-screen area including an image b3 developed therein. The lowermost row is composed of a one-screen area including an image c1 developed therein, a one-screen area including an image c2 developed therein and a one-screen area including an image c3 developed therein.

In the VRAM map, when the display area is located in the area of the image b2 and thus the image b2 is displayed for example, push-in displaying can be carried out in any direction of the upward, downward, left and right directions. Specifically, if the display area is moved to the area of the image c2 (in the downward direction), the effect direction is the upward direction and therefore push-in displaying in the upward direction is implemented. If the display area is moved to the area of the image a2 (in the upward direction), the effect direction is the downward direction and therefore push-in displaying in the downward direction is implemented. If the display area is moved to the area of the image b3 (in the right direction), the effect direction is the left direction and therefore push-in displaying in the left direction is implemented. If the display area is moved to the area of the image b1 (in the left direction), the effect direction is the right direction and therefore push-in displaying in the right direction is implemented.

However, when the display area is located in the area of the image a1 and thus the image a1 is displayed for example, the display area can only move to the area of the image a2 (in the right direction) or to the area of the image b1 (in the downward direction). That is, in this case, the effect direction of possible push-in displaying is limited to the left direction or the upward direction.

In order to address this disadvantage, a method is proposed in Japanese Patent Laid-open No. Hei 5-204372 in which combinations of areas are set using a look-up table and the arrangement of the areas (banks) is converted according to the setting of the display beginning position (reference address), to thereby use four frame memories as if eight frame memories existed.

That is, a large virtual address space can be set using the arrangement and combination of areas disclosed in Japanese Patent Laid-open No Hei 5-204372. For example, when the display area is located in the area of the image a3 and thus the image a3 is displayed, successive displaying is allowed by folding back the display area within the area of the image a3, or folding back it to the area of the image a1.

However, in the above-described proposal, the arrangement and combination of areas need to be set in order to set a large virtual address space, and this setting is problematically complicated. In addition, a hardware configuration that produces addresses for using the virtual address space is also problematically complicated. Moreover, a ring buffer configuration causes the need for more complicated address control.

The present invention is made in consideration of such circumstances, and an object thereof is to easily allow successive effect displaying of images.

### SUMMARY OF THE INVENTION

According to one embodiment of the present invention, there is provided an information processing that includes: a range moving unit that moves a display range within areas, on a memory, in which image data retrieved from a recording medium is developed, the display range being a range that includes image data of an image to be displayed; an image determining unit that determines, upon movement of the display range to a one-screen first area by the range moving unit and displaying of an image corresponding to first image data developed in the first area, whether or not second image data has been developed in a destination in a movement direction of the next movement of the display range; a duplicating unit that duplicates the first image data in a one-screen second area on the opposite side of the destination in the movement direction of the display range, if the image determining unit determines that the second image data has not been developed in the destination in the movement direction of the display range; and an image developing unit that develops the second image data in the first area upon movement of the display range by the range moving unit to the second area in which the first image data has been duplicated by the duplicating unit and displaying of an image corresponding to the first image data that has been duplicated in the second area by the duplicating unit.

According to another embodiment of the present invention, there is provided an information processing method that includes the steps of: moving a display range within areas, on a memory, in which image data retrieved from a recording medium is developed, the display range being a range that includes image data of an image to be displayed; determining, when the display range is moved to a one-screen first area due to processing of the moving and an image corresponding to first image data developed in the first area is displayed, whether or not second image data has been developed in a destination in a movement direction of the next movement of the display range; duplicating the first image data in a one-screen second area on the opposite side of the destination in the movement direction of the display range, if processing of the determining results in a determination that the second image data has not been developed in the destination in the movement direction of the display range; and developing the second image data in the first area when the display range is moved, due to processing of the moving, to the second area in which the first image data has been duplicated due to processing of the duplicating and an image corresponding to the first image data that has been duplicated in the second area due to processing of the duplicating is displayed.

According to still another embodiment of the present invention, there is provided a recording medium that records therein a program including the steps of: moving a display range within areas, on a memory, in which image data retrieved from a recording medium is developed, the display range being a range that includes image data of an image to be displayed; determining, when the display range is moved to a one-screen first area due to processing of the moving and an image corresponding to first image data developed in the first area is displayed, whether or not second image data has been developed in a destination in a movement direction of the next movement of the display range; duplicating the first image data in a one-screen second area on the opposite side of the destination in the movement direction of the display range, if processing of the determining results in a determination that the second image data has not been developed in the destination in the movement direction of the display range; and developing the second image data in the first area when the display range is moved, due to processing of the moving, to the second area in which the first image data has been duplicated due to processing of the duplicating and an image corresponding to the first image data that has been duplicated in the second area due to processing of the duplicating is displayed.

According to a further embodiment of the present invention, there is provided a program that includes the steps of: moving a display range within areas, on a memory, in which image data retrieved from a recording medium is developed, the display range being a range that includes image data of an image to be displayed; determining, when the display range is moved to a one-screen first area due to processing of the moving and an image corresponding to first image data developed in the first area is displayed, whether or not second image data has been developed in a destination in a movement direction of the next movement of the display range; duplicating the first image data in a one-screen second area on the opposite side of the destination in the movement direction of the display range, if processing of the determining results in a determination that the second image data has not been developed in the destination in the movement direction of the display range; and developing the second image data in the first area when the display range is moved, due to processing of the moving, to the second area in which the first image data has been duplicated due to processing of the duplicating and an image corresponding to the first image data that has been duplicated in the second area due to processing of the duplicating is displayed.

According to the embodiments of the present invention, in areas, on a memory, in which image data retrieved from a recording medium is developed, when a display range for displaying an image corresponding to the image data therein has been moved to a one-screen first area and the image of first image data developed in the first area is displayed, a determination is made as to whether or not second image data has been developed in the destination in the movement direction of the next movement of the display range. If a determination is made that the second image data has not been developed in the movement destination of the display range, the first image data is duplicated in a one-screen second area on the opposite side of the movement destination of the display range. Subsequently, when the display range has been moved to the second area in which the first image data has been duplicated and the image of the first image data duplicated in the second area is displayed, the second image data is developed in the first area.

### BRIEF DESCRIPTION OF THE DRAWINGS

FIGS. 1A to 1C are diagrams illustrating a configuration example of a conventional VRAM map;

FIG. 2 is a diagram illustrating another configuration example of a conventional VRAM map;

FIG. 3 is a block diagram illustrating a configuration example of a recording and reproducing device according to one embodiment of the present invention;

FIG. 4 is a block diagram illustrating a detailed configuration example of a display control unit shown in FIG. 3 for implementing push-in displaying;

FIGS. 5A to 5F are diagrams illustrating push-in displaying with its effect direction being the upward direction according to one embodiment;

FIGS. 6A to 6F are diagrams illustrating push-in displaying with its effect direction being the downward direction according to one embodiment;

FIGS. 7A to 7F are diagrams illustrating push-in displaying with its effect direction being the right direction according to one embodiment;

FIGS. 8A to 8F are diagrams illustrating push-in displaying with its effect direction being the left direction according to one embodiment;

FIG. 9 is a diagram illustrating a configuration example of a map of the VRAM of FIG. 4;

FIG. 10 is a diagram illustrating push-in displaying in an oblique direction in the VRAM map of FIG. 9;

FIG. 11 is a flowchart illustrating push-in displaying processing in the recording and reproducing device of FIG. 3;

FIG. 12 is a flowchart illustrating display control processing in a step S13 of FIG. 11; and

FIG. 13 is a block diagram illustrating a configuration example of a personal computer according to one embodiment of the present invention.

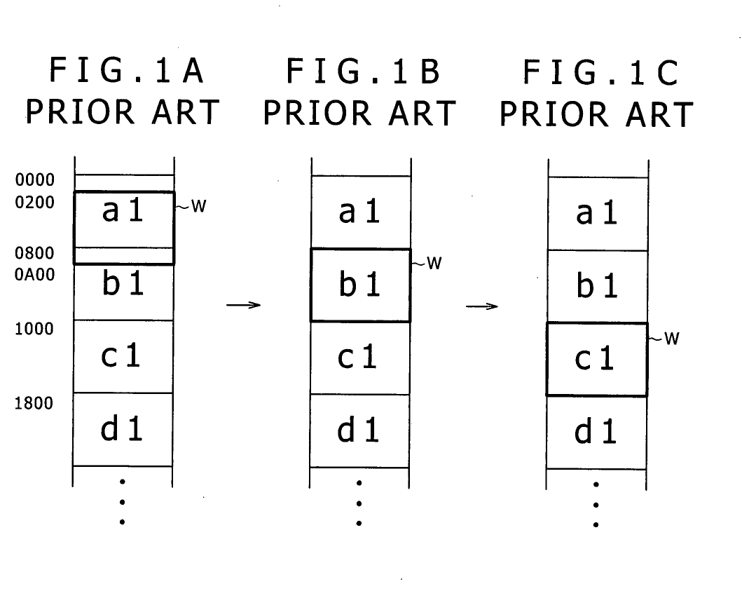

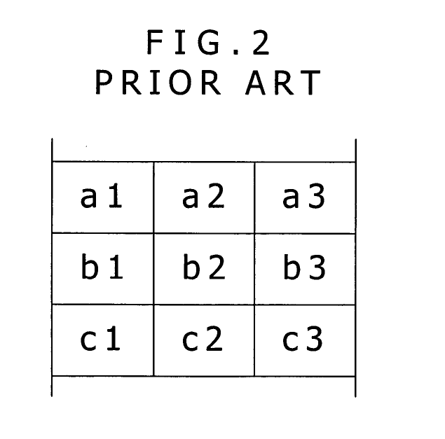

### DETAILED DESCRIPTION OF THE PREFERRED EMBODIMENTS

Embodiments of the present invention will be described below with reference to the accompanying drawings.

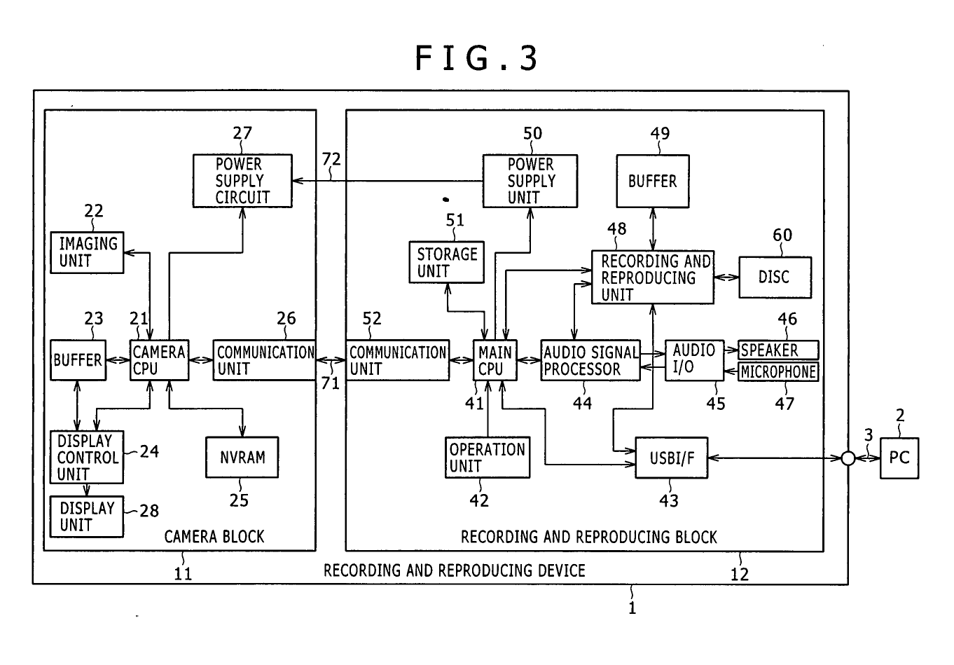

FIG. 3 is a block diagram illustrating a configuration example of a recording and reproducing device according to one embodiment of the present invention.

Referring to FIG. 3, a recording and reproducing device 1 and a PC (personal computer) 2 are coupled to each other via a USB (universal serial bus) cable 3, which allows bidirectional communication therebetween.

The recording and reproducing device 1 includes a camera block 11 and a recording and reproducing block 12.

The camera block 11 includes a camera CPU 21, an imaging unit 22, a buffer 23, a display control unit 24, an NVRAM (non-volatile random access memory) 25, a communication unit 26, a power supply circuit 27, and a display unit 28. The camera block 11 controls imaging processing by the imaging unit 22 and displaying of images by the display unit 28.

The recording and reproducing block 12 includes a main CPU 41, an operation unit 42, a USB I/F (universal serial bus interface) 43, an audio signal processor 44, an audio input/output (I/O) 45, a speaker 46, a microphone 47, a recording and reproducing unit 48, a buffer 49, a power supply unit 50, a storage 51, and a communication unit

The recording and reproducing block 12 controls recording and retrieving of images or musical pieces (data) in and from a disk 60 fitted to the recording and reproducing unit 48.

The communication unit 26 in the camera block 11 and the communication unit 52 in the recording and reproducing block 12 are coupled to each other via a serial bus 71, which allows the blocks 11 and 12 to exchange various kinds of data therebetween according to need.

The camera CPU 21 in the camera block 11 transmits and receives data by serial communication to and from the main CPU 41 in the recording and reproducing block 12 via the communication unit 26, the serial bus 71 and the communication unit 52, under control by the main CPU 41 in the recording and reproducing block 12. The camera CPU 21 controls each part in the camera block 11 in accordance with a command transmitted by serial communication from the main CPU 41 in the recording and reproducing block 12 via the communication unit 52, the serial bus 71 and the communication unit 26.

For example, the camera CPU 21 controls the imaging unit 22 according to a command transmitted from the main CPU 41, to thereby image an object. The camera CPU 21 supplies to the buffer 23 an image (data) of the object resulting from the imaging and supplied from the imaging unit 22. In addition, the camera CPU 21 retrieves image data from the buffer 23 according to a command transmitted from the main CPU 41, and then implements JPEG (Joint Photographic Experts Group) encoding for the image data for example. The camera CPU 21 then transmits the encoded image data to the main CPU 41.

Furthermore, the camera CPU 21 stores image data transmitted from the main CPU 41 in accordance with a command transmitted from the main CPU 41 for example, and controls the display control unit 24 so that it retrieves image data from the buffer 23 and supplies the image data to the display unit 28 in accordance with a command transmitted from the main CPU 41. In addition, the camera CPU 21 retrieves from the NVRAM 25 data of images having a high likelihood of being displayed on the display unit 28 plural times (hereinafter referred to as fixed image data), such as an icon image, background image and counter image, and then supplies the retrieved data to the display control unit 24.

The imaging unit 22 is made up of an imaging element such as a CMOS (complementary metal oxide semiconductor) or a CCD (charge coupled device), or an AF (auto focus) module. The imaging unit 22 implements image capturing with focusing on an object and provides a captured image (data) to the camera CPU 21. The buffer 23 temporarily stores image data from the camera CPU 21.

Under control by the camera CPU 21, the display control unit 24 retrieves image data accumulated in the buffer 23, and produces data of images to be displayed with using the retrieved image data and fixed image data supplied from the camera CPU 21, and then implements control to cause the display unit 28 to display the corresponding images. Specifically, the display control unit 24 causes the display unit 28 to display images corresponding to image data as they are, or display a list of images corresponding to image data, or alternatively display images corresponding to image data with a push-in effect.

Here, the displaying with a push-in effect (hereinafter referred to as push-in displaying) is one of ways of effect displaying for images. In the push-in displaying, images are successively displayed in such a manner that, after one image is displayed, the next image emerges as if it pushed out the previous image. In the push-in displaying, the time period for displaying an entire one image after push-in emergence is about three seconds, and the direction in which images are (look to be) pushed out is referred to as an effect direction.

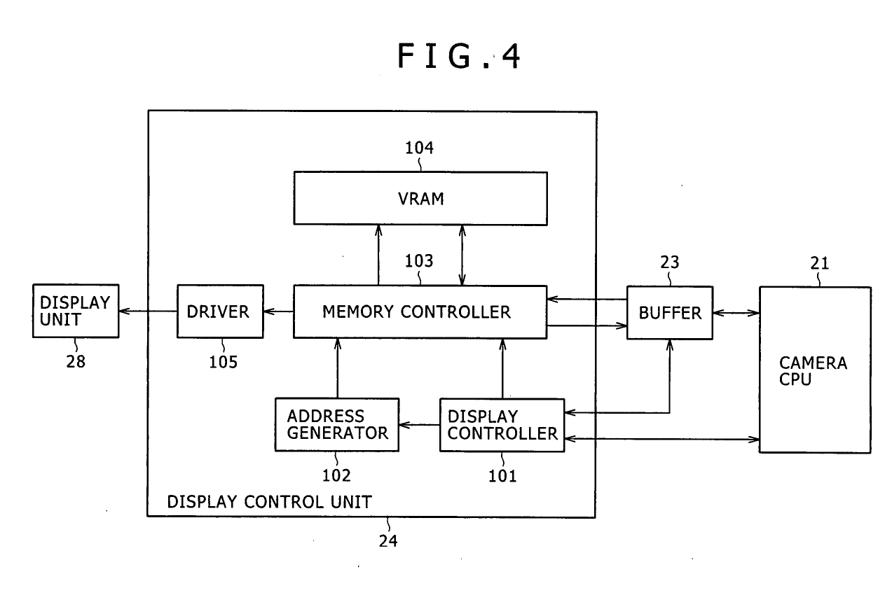

Specifically, the display control unit 24 controls push-in displaying in an effect direction by repeating the following steps: (a) retrieving image data from the buffer 23 in a random manner; (b) decoding (decompressing) the image data and then recording (i.e., developing) the decoded image data in a video random access memory (VRAM) 104 (FIG. 4); (c) moving a display beginning position (display area) for the image data developed in the VRAM 104 in the opposite direction of the effect direction; and (d) supplying the display unit 28 with the image data in the area starting from the moved display beginning position.

The NVRAM 25 is rewritable memory, and stores fixed image data. The fixed image data stored in the NVRAM 25 is rewritten by the camera CPU 21 according to a command transmitted from the main CPU 41.

The communication unit 26 transmits and receives a communication control signal to and from the communication unit 52 in the recording and reproducing block 12 via the serial bus 71, to thereby transmit and receive various kinds of data by serial communication, under control by the camera CPU 21.

The power supply circuit 27 is coupled to the power supply unit 50 in the recording and reproducing block 12 via a power supply line 72, and is supplied with power from the power supply unit 50 via the power supply line 72. The power supply circuit 27 supplies each part in the camera block 11 with the power from the power supply unit 50 under control by the camera CPU 21.

The display unit 28 is made up of a liquid crystal display for example, and displays images corresponding to image data from the display control unit 24.

The main CPU 41 in the recording and reproducing block 12 records (writes) and retrieves data of images and musical pieces in and from the disk 60, and implements various kinds of computation and control of each part in order to play musical pieces and so on, in response to an operation signal from the operation unit 42 for example. In addition, the main CPU 41 generates a command for controlling each part of the camera block 11, and transmits the command to the camera CPU 21 in the camera block 11 via the communication unit 52, the serial bus 71, and the communication unit 26, in response to an operation signal from the operation unit 42. That is, the main CPU 41 also controls communication between the recording and reproducing block 12 and the camera block 11.

The operation unit 42 is made up of buttons, dials and the like provided on the surface of the recording and reproducing device 1 for example. The operation unit 42 accepts an instruction from a user to the recording and reproducing device 1 in regard to imaging, displaying of images, playing of musical pieces or the like, and supplies an operation signal indicating the instruction to the main CPU 41. The USB I/F 43 supplies data of images and musical pieces from the recording and reproducing unit 48 to the PC 2 via the USB cable 3 under control by the main CPU 41. Moreover, supplied to the USB I/F 43 from the PC 2 is downloaded data of images and musical pieces for example, and the USB I/F 43 supplies the recording and reproducing unit 48 with the data of images and musical pieces.

The audio signal processor 44 implements 1-7 RLL (1-7 Run-Length Limited coding) modulation processing for data of musical pieces from the main CPU 41 for example, and supplies the processed data to the recording and reproducing unit 48. Furthermore, the audio signal processor 44 implements 1-7 RLL demodulation processing for data of musical pieces from the recording and reproducing unit 48, and supplies the processed data to the audio I/O 45.

The audio I/O 45 supplies the speaker 46 with audio corresponding to data of musical pieces from the audio signal processor 44. In addition, the audio I/O 45 supplies the audio signal processor 44 with audio from the microphone 47. The speaker 46 outputs audio from the audio I/O 45 to the external. The microphone 47 supplies the audio I/O 45 with audio obtained from the external.

The recording and reproducing unit 48 supplies the buffer 49 with data of images and musical pieces retrieved from the disk 60, and retrieves data of image and musical pieces stored in the buffer 49, under control by the main CPU 41. As the disk 60, an optical disk (CD (compact disc), DVD (digital versatile disk), etc.), a magnet-optical disk (MD (mini-disc), Hi-MD (hi-mini-disk) (trademark), etc.), a magnetic disk, or the like is available.

The recording and reproducing unit 48 supplies the audio signal processor 44 with data of musical pieces retrieved from the buffer 49, and records in the disk 60 data of musical pieces supplied from the audio signal processor 44. Moreover, the recording and reproducing unit 48 supplies the main CPU 41 with data of images retrieved from the buffer 49, and records in the disk 60 data of images supplied from the main CPU 41.

The buffer 49 stores data of images and musical pieces that has been retrieved from the disk 60 and is supplied from the recording and reproducing unit 48.

The power supply unit 50 supplies power to each part in the recording and reproducing block 12 according to the operational state of the recording and reproducing block 12 under control by the main CPU 41. The power supply unit 50 also supplies power via the power supply line 72 to the power supply circuit 27 in the camera block 11 under control by the main CPU 41.

The storage 51 stores information relating to fixed image data stored in the NVRAM 25 (hereinafter referred to as fixed image data information) for example. The main CPU 41 retrieves fixed image data information from the storage 51, and transmits a command that directs displaying of images based on the fixed image data information to the camera CPU 21 via the communication unit 52, the serial bus 71 and the communication unit 26.

The communication unit 52 transmits and receives a communication control signal to and from the communication unit 26 in the camera block 11 via the serial bus 71, to thereby transmit and receive various kinds of data by serial communication, under control by the main CPU 41.

In the recording and reproducing device 1 having the above-described configuration, the main CPU 41 takes a role of controlling the entire device 1 and controlling communication. Specifically, the main CPU 41 controls each part of the recording and reproducing block 12. In addition, the main CPU 41 generates a command for controlling each part in the camera block 11 and transmits the command to the camera CPU 21 in the camera block 11, in response to an operation signal from the operation unit 42.

Thus, in the recording and reproducing device 1, the camera CPU 21 causes the display unit 28 to display, in a list form or push-in displaying form, images corresponding to image data transmitted from the main CPU 41, in accordance with a command transmitted from the main CPU 41 via the serial bus 71. In addition, the camera CPU 21 transmits to the main CPU 41 image data resulting from image capturing according to a command transmitted from the main CPU 41, and then the main CPU 41 causes the disk 60 to record the image data therein. Moreover, the main CPU 41 causes the speaker 46 to output audio corresponding to data of musical pieces recorded in the disk 60.

FIG. 4 illustrates a detailed configuration example of the display control unit that executes push-in displaying.

Referring to the example of FIG. 4, the camera CPU 21 accumulates in the buffer 23 image data (e.g., image data for thumbnail view) transmitted from the main CPU 41 in the recording and reproducing block 12 via the communication unit 26, the serial bus 71 and the communication unit 52. The camera CPU 21 induces a display controller 101 to initialize push-in displaying in response to a command transmitted from the main CPU 41 via the serial bus 71. Furthermore, when the amount of image data accumulated in the buffer 23 becomes smaller than a certain value, the camera CPU 21 requires image data of the main CPU 41 in the recording and reproducing block 12 via the communication unit 52, the serial bus 71, and the communication unit 26.

The buffer 23 can accumulate about sixty image data pieces to be used in the push-in displaying.

The display control unit 24 includes the display controller 101, an address generator 102, a memory controller 103, the VRAM 104, and a driver 105.

The display controller 101 randomly selects image data among image data accumulated in the buffer 23, and controls the memory controller 103 so that the controller 103 retrieves the selected image data and develops the retrieved image data in the VRAM 104, and so that the controller 103 duplicates image data developed in the VRAM 104. In addition, with referring to a VRAM map (virtual address space) in the VRAM 104, the display controller 101 instructs the address generator 102 which area image data is to be developed in, and directs the address generator 102 to move a display beginning position that is the beginning address of a display area, which includes image data of an image to be displayed on the display unit 28. At this time, the display controller 101 indicates a movement leg and movement time, specifically, the beginning and end addresses of the movement and the number of seconds the movement takes, for example.

Furthermore, the display controller 101 implements time counting operation with a clock (not shown) incorporated therein, to thereby control the displaying time for an entire one image after push-in emergence and the displaying movement time it takes for an image to be completely replaced by the next image. Specifically, the display controller 101 determines whether or not the movement time has elapsed, i.e., whether or not the display beginning position corresponds with the beginning address of a certain area, to thereby determine whether or not the currently displayed image is an entire one image after completion of push-in emergence. If a determination is made that the currently displayed image is an entire one image, the display controller 101 determines the movement direction of the display beginning position (display area) (i.e., the opposite direction of the effect direction), and then determines whether or not a one-screen area in which image data corresponding to the image to be displayed next has been developed exists in the destination in the determined movement direction.

If a determination is made that a one-screen area in which image data corresponding to the image to be displayed next has been developed does not exist in the destination in the determined movement direction, the display controller 101 controls the address generator 102 and the memory controller 103 so that the image data corresponding to the currently displayed image is duplicated in the one-screen area on the opposite side of the destination in the determined movement direction. The display controller 101 then instructs the address generator 102 to move the display beginning position to the one-screen area in which the duplicated image data has been developed. Subsequently, the display controller 101 causes the address generator 102 and the memory controller 103 to retrieve randomly selected image data and develop it in the one-screen area in which the original image data (origin of the duplication) has been developed. In addition, the display controller 101 instructs the address generator 102 to move the display beginning position.

The address generator 102 has an address conversion table for address conversion between the VRAM map (virtual address space) to which the display controller 101 refers and the address space in the VRAM 104. The address generator 102 generates (converts) an address in the VRAM 104 based on the area, or the movement lag and movement time indicated by the display controller 101, and supplies the generated address to the memory controller 103.

Under control by the display controller 101, the memory controller 103 retrieves image data accumulated in the buffer 23, and then develops the retrieved image data in a certain one-screen area in the VRAM 104 based on the address supplied from the address generator 102. That is, the memory controller 103 decodes retrieved image data and records (stores) it in a certain one-screen area in the VRAM 104.

In addition, under control by the display controller 101, the memory controller 103 duplicates and records image data developed (recorded) in one area in the VRAM 104 in another area based on the address supplied from the address generator 102. Moreover, the memory controller 103 retrieves image data in the display area based on the address supplied from the address generator 102, and then supplies the retrieved image data to the display unit 28 via the driver 105.

The VRAM 104 is composed of at least two one-screen areas. The memory controller 103 develops image data retrieved from the buffer 23 in the one-screen areas, and of the developed image data, the image data in the display area starting from the display beginning position is retrieved. The driver 105 supplies the image data from the memory controller 103 to the display unit 28.

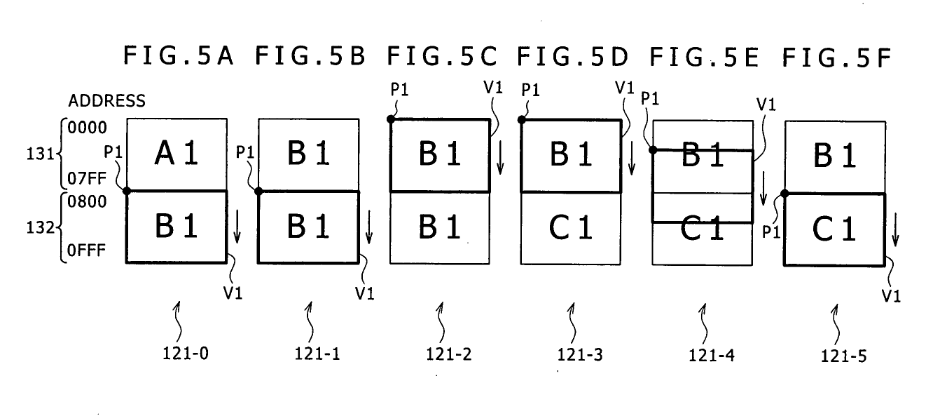

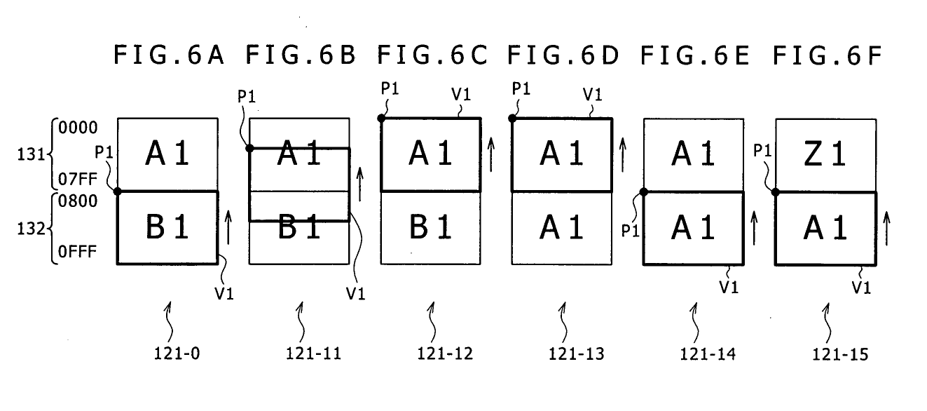

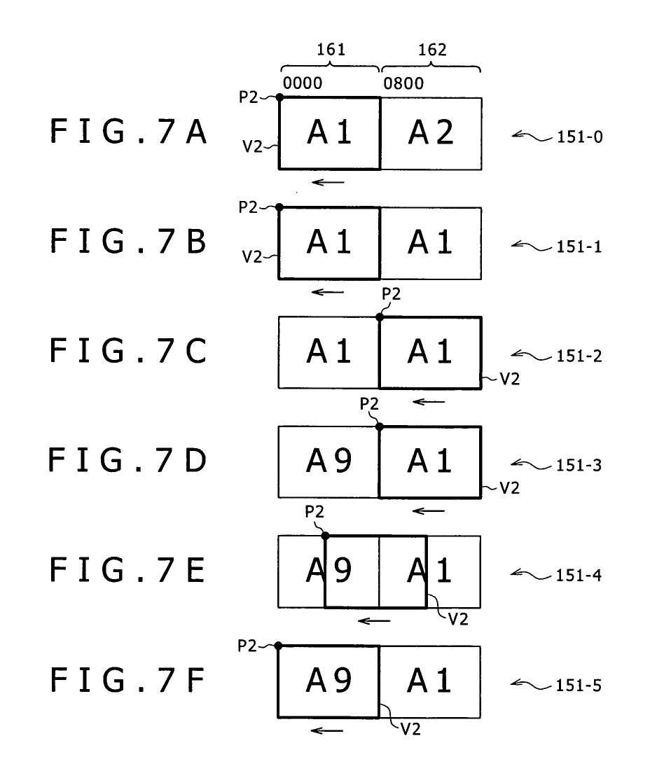

Push-in displaying in the upward and downward directions executed by the display control unit of FIG. 4 will be described below with reference to FIGS. 5A to 5F and 6A to 6F.

FIGS. 5A to 5F and 6A to 6F illustrate the states of a VRAM map 121 that is the virtual address space in the VRAM 104 for push-in displaying in the upward and downward directions. The addresses indicated on the left of the drawings are the actual addresses in the VRAM 104 corresponding to the VRAM map 121. Referring to FIGS. 5A to 5F and 6A to 6F, the VRAM map 121 is composed of a one-screen area 131 and a one-screen area 132 that are vertically arranged in that order from the upside of the VRAM map 121. The one-screen area 131 is the area from address 0000 to address 07FF, and the one-screen area 132 is the area from address 0800 to address 0FFF.

Note that the branch numbers of the reference numerals of a VRAM map 121-0 of FIG. 5A, VRAM maps 121-1 to 121-5 of FIGS. 5B to 5F, a VRAM map 121-0 of FIG. 6A and VRAM maps 121-11 to 121-15 of FIGS. 6B to 6F indicate the order of the processing. Indicated for each VRAM map 121 are a display area V1 and a display beginning position P1, which is the beginning address of the display area V1, at the time of the corresponding processing. The arrow on the right of the display area V1 indicates the movement direction of the display beginning position P1 (display area V1).

Initially, push-in displaying with its effect direction being the upward direction will be described with reference to FIGS. 5A to 5F.

The memory controller 103 retrieves from the buffer 23 the image data of an image A1 and an image B1 and develops (decodes and records) the image data of the images A1 and B1 in the areas 131 and 132, respectively, as shown in the VRAM map 121-0 of FIG. 5A. Under control by the display controller 101, the address generator 102 instructs the memory controller 103 to move the display beginning position P1 to address 0800 (the beginning address of the area 132).

The memory controller 103 moves the display beginning position P1 to address 0800 in the VRAM 104. The memory controller 103 then retrieves the image data in the display area V1 starting from address 0800 (the image data of the image B1 developed in the area 132) and supplies the image data to the display unit 28 via the driver 105. Thus, the display unit 28 displays the image B1 corresponding to the image data developed in the area 132.

Upon the displaying of the image B1, which is an entire one image, the display controller 101 determines which of the upward and downward directions is to be employed as the movement direction of the display beginning position P1, while keeping on the displaying of the image B1 for a certain period (e.g., three seconds). Since the effect direction is the upward direction in the example of FIGS. 5A to 5F, the display controller 101 determines to use the downward direction as the movement direction of the display beginning position P1. Subsequently, the display controller 101 determines whether or not a one-screen area in which an image to be displayed next has been developed exists in the destination in the movement direction of the display beginning position P1, i.e., in the downward direction.

In the example of FIG. 5A, a one-screen area in which an image to be displayed next has been developed is absent in the destination below the area 132 in the VRAM map 121-0. Therefore, the display controller 101 controls the address generator 102 and the memory controller 103 so that the image data of the currently displayed image B1 is duplicated in the area 131, which is on the opposite side of the movement destination of the display beginning position P1, as shown in the VRAM map 121-1 of FIG. 5B.

After the memory controller 103 duplicates and records in the area 131 in the VRAM 104 (VRAM map 121-1), the image data of the image B1 developed in the area 132, the display controller 101 controls the address generator 102 so that the display beginning position P1, which has been located on the beginning address of the area 132 (address 0800), is moved to the beginning address of the area 131 (address 0000) as shown in the VRAM map 121-2 of FIG. 5C.

Specifically, with referring to the address conversion table, the address generator 102 generates the beginning address of the area 131 (address 0000) and supplies address 0000 to the memory controller 103. The memory controller 103 moves the display beginning position P1 to address 0000 in the VRAM 104, supplied from the address generator 102. The memory controller 103 then retrieves the image data in the display area V1 starting from address 0000 (i.e., the image data of the image B1 developed in the area 131) and supplies the image data to the display unit 28 via the driver 105.

Thus, the display unit 28 displays the image B1 corresponding to the image data developed in the area 131. Since the same image B1 is successively displayed, a user viewing the display unit 28 does not recognize that the duplicated image B1 replaces the previous image B1.

The display controller 101 then controls the address generator 102 and the memory controller 103 so that the image data of a randomly selected image C1 is retrieved from the buffer 23, followed by being developed in the area 132 outside the display area V1 as shown in the VRAM map 121-3 of FIG. 5D. Subsequently, the display controller 101 controls the address generator 102 so that, as shown in the VRAM map 121-4 of FIG. 5E, the display beginning position P1 is sequentially moved in the downward direction in the drawing across the movement leg from the beginning address of the area 131 (address 0000) to the beginning address of the area 132 (address 0800) during certain movement time.

Specifically, the address generator 102 generates addresses and supplies the generated addresses to the memory controller 103 sequentially with referring to the address conversion table so that the display beginning position P1 is sequentially moved across the movement leg from address 0000 to address 0800 during certain movement time.

The memory controller 103 sequentially moves the display beginning position P1 and the display area V1 in the range from address 0000 to address 0800 based on the addresses supplied from the address generator 102. Furthermore, after each movement, the memory controller 103 retrieves the image data in the display area V1 starting from the display beginning position P1 and supplies the image data to the display unit 28 via the driver 105.

Thus, the display unit 28 sequentially displays the images corresponding to the image data included in the display area V1. Initially, the percentage of image data of the image B1 is large in the entire image data included in the display area V1. However, since the display beginning position P1 sequentially moves in the downward direction, the percentage of image data of the image C1 increases every time the image data in the display area V1 is sequentially retrieved. Specifically, the sequential movement of the display beginning position P1 in the range from address 0000 to address 0800 allows the display unit 28 to display the images as if the image B1 was pushed out by the image C1 in the upward direction in the drawing, which achieves push-in displaying in the upward direction.

The processing of thus sequentially moving the display beginning position P1 and the display area V1 in the range from address 0000 to address 0800 is repeated until address 0800 is specified as the display beginning position P1. Eventually, according to an instruction from the address generator 102, the memory controller 103 moves the display beginning position P1 to address 0800 (the beginning address of the area 132) in the VRAM 104, as shown in the VRAM map 121-5 of FIG. 5F. The memory controller 103 then retrieves the image data in the display area V1 starting from address 0800 (i.e., the image data of the image C1 developed in the area 132) and supplies the image data to the display unit 28 via the driver 105.

Thus, the display unit 28 displays the image C1 corresponding to the image data developed in the area 132.

At this time, address 0800 specified as the display beginning position P1 is the beginning address of the area 132, and therefore the movement time indicated to the address generator 102 has elapsed. Consequently, the display controller 101 determines which of the upward and downward directions is to be employed as the next movement direction of the display beginning position P1. Since the effect direction is the upward direction in the example of FIGS. 5A to 5F, the display controller 101 determines to use the downward direction as the movement direction of the display beginning position P1. Subsequently, the display controller 101 determines whether or not a one-screen area in which an image to be displayed next has been developed exists in the destination in the movement direction of the display beginning position P1 (i.e., in the downward direction).

In the example of FIG. 5F, as with the VRAM map 121-0, a one-screen area in which an image to be displayed next has been developed is absent in the destination below the area 132 in the VRAM map 121-5. Therefore, the display controller 101 controls the address generator 102 and the memory controller 103 so that the image data of the currently displayed image C1 is duplicated in the area 131, which is on the opposite side of the movement destination of the display beginning position P1. After this duplication, the similar processing to that subsequent to the processing indicated with the VRAM map 121-1 is repeated, with developed and displayed images being replaced by other images.

As described above, push-in displaying with its effect direction being the upward direction is successively executed.

Push-in displaying with its effect direction being the downward direction will be described with reference to FIGS. 6A to 6F. Note that detailed description of the same processing in FIG. 6A to 6F as that in FIG. 5A to 5F will be adequately omitted in order to avoid redundant repetition.

The memory controller 103 retrieves from the buffer 23 the image data of the images A1 and B1 and develops the image data of the images A1 and B1 in the areas 131 and 132, respectively, as shown in the VRAM map 121-0 of FIG. 6A. Under control by the display controller 101, the address generator 102 instructs the memory controller 103 to move the display beginning position P1 to address 0800 (the beginning address of the area 132).

The memory controller 103 moves the display beginning position P1 to address 0800 in the VRAM 104. The memory controller 103 then retrieves the image data in the display area V1 starting from address 0800 (the image data of the image B1 developed in the area 132) and supplies the image data to the display unit 28 via the driver 105. Thus, the display unit 28 displays the image B1 corresponding to the image data developed in the area 132.

Upon the displaying of the image B1, which is an entire one image, the display controller 101 determines which of the upward and downward directions is to be employed as the movement direction of the display beginning position P1, while keeping on the displaying of the image B1 for a certain period (e.g., three seconds). Since the effect direction is the downward direction in the example of FIGS. 6A to 6F, the display controller 101 determines to use the upward direction as the movement direction of the display beginning position P1. Subsequently, the display controller 101 determines whether or not a one-screen area in which an image to be displayed next has been developed exists in the destination in the movement direction of the display beginning position P1 (i.e., in the upward direction).

In the example of FIG. 6A, the one-screen area 131, in which the image to be displayed next has been developed, is present in the destination above the area 132 in the VRAM map 121-0. Therefore, the display controller 101 controls the address generator 102 so that, as shown in the VRAM map 121-11 of FIG. 6B, the display beginning position P1 is sequentially moved in the upward direction in the drawing across the movement leg from the beginning address of the area 132 (address 0800) to the beginning address of the area 131 (address 0000) during certain movement time.

Specifically, the address generator 102 generates addresses and supplies the generated addresses to the memory controller 103 sequentially with referring to the address conversion table so that the display beginning position P1 is sequentially moved across the movement leg from address 0800 to address 0000 during certain movement time.

The memory controller 103 sequentially moves the display beginning position P1 and the display area V1 in the range from address 0800 to address 0000 of the VRAM 104 in the upward direction in the drawing based on the addresses supplied from the address generator 102. Furthermore, after each movement, the memory controller 103 retrieves the image data in the display area V1 starting from the display beginning position P1 and supplies the image data to the display unit 28 via the driver 105.

Thus, the display unit 28 sequentially displays the images corresponding to the image data included in the display area V1. Initially, the percentage of image data of the image B1 is large in the entire image data included in the display area V1. However, since the display beginning position P1 sequentially moves in the upward direction, the percentage of image data of the image A1 increases every time the image data in the display area V1 is sequentially retrieved. Specifically, the sequential movement of the display beginning position P1 in the range from address 0800 to address 0000 allows the display unit 28 to display the images as if the image B1 was pushed out by the image A1 in the downward direction in the drawing, which achieves push-in displaying in the downward direction.

The processing of thus sequentially moving the display beginning position P1 and the display area V1 in the range from address 0800 to address 0000 of the VRAM 104 is repeated until address 0000 is specified as the display beginning position P1. Eventually, according to an instruction from the address generator 102, the memory controller 103 moves the display beginning position P1 to address 0000 (the beginning address of the area 131) in the VRAM 104, as shown in the VRAM map 121-12 of FIG. 6C. The memory controller 103 then retrieves the image data in the display area V1 starting from address 0000 (i.e., the image data of the image A1 developed in the area 131) and supplies the image data to the display unit 28 via the driver 105.

Thus, the display unit 28 displays the image A1 corresponding to the image data developed in the area 131. At this time, address 0000 specified as the display beginning position P1 is the beginning address of the area 131, and therefore the movement time indicated to the address generator 102 has elapsed. Consequently, the display controller 101 determines which of the upward and downward directions is to be employed as the next movement direction of the display beginning position P1. Since the effect direction is the downward direction in the example of FIGS. 6A to 6F, the display controller 101 determines to use the upward direction as the movement direction of the display beginning position P1. Subsequently, the display controller 101 determines whether or not a one-screen area in which an image to be displayed next has been developed exists in the destination in the movement direction of the display beginning position P1 (i.e., in the upward direction).

In the example of FIG. 6C, a one-screen area in which an image to be displayed next has been developed is absent in the destination above the area 131 in the VRAM map 121-12. Therefore, the display controller 101 controls the address generator 102 and the memory controller 103 so that the image data of the currently displayed image A1 is duplicated in the area 132, which is on the opposite side of the movement destination of the display beginning position P1, as shown in the VRAM map 121-13 of FIG. 6D.

After the memory controller 103 duplicates and records in the area 132 in the VRAM 104 (the VRAM map 121-13 of FIG. 6D), the image data of the image A1 developed in the area 131, the display controller 101 controls the address generator 102 so that the display beginning position P1, which has been located on the beginning address of the area 131 (address 0000), is moved to the beginning address of the area 132 (address 0800) as shown in the VRAM map 121-14 of FIG. 6E.

Specifically, with referring to the address conversion table, the address generator 102 generates the beginning address of the area 132 (address 0800) and supplies address 0800 to the memory controller 103. The memory controller 103 moves the display beginning position P1 to address 0800 in the VRAM 104, supplied from the address generator 102. The memory controller 103 then retrieves the image data in the display area V1 starting from address 0800 (i.e., the image data of the image A1 developed in the area 132) and supplies the image data to the display unit 28 via the driver 105.

Thus, the display unit 28 displays the image A1 corresponding to the image data developed in the area 132. Since the same image A1 is successively displayed, a user viewing the display unit 28 does not recognize that the duplicated image A1 replaces the previous image A1.

The display controller 101 then controls the address generator 102 and the memory controller 103 so that the image data of a randomly selected image Z1 is retrieved from the buffer 23, followed by being developed in the area 131 outside the display area V1 as shown in the VRAM map 121-15 of FIG. 6F. Subsequently, the display controller 101 controls the address generator 102 so that the display beginning position P1 is sequentially moved in the upward direction in the drawing across the movement leg from the beginning address of the area 132 (address 0800) to the beginning address of the area 131 (address 0000) during certain movement time.

Thus, the display unit 28 sequentially displays the images corresponding to the image data included in the display area V1, and the similar processing to that subsequent to the processing indicated with the VRAM map 121-11 of FIG. 6B is executed, with developed and displayed images being replaced by other images.

As described above, push-in displaying with its effect direction being the downward direction is successively executed.

As described above, in push-in displaying with its effect direction being the upward and downward directions, the following processing sequence is repeated: when the image data of an image to be displayed next is not developed in the destination in the movement direction of the display beginning position, (a) duplicating the image data of the currently displayed image in the area opposite to the movement destination; (b) moving the display beginning position to the area in which the duplicated image data has been developed; and (c) developing the image data of the image to be displayed next in the destination of the moved display beginning position. Thus, the push-in displaying can be repeated infinitely as long as the VRAM has at least two one-screen areas.

In this case, since the image data of the currently displayed image is duplicated, the amount of image data retrieved from the VRAM 104 does not become large, which suppresses delays of the retrieving of image data.

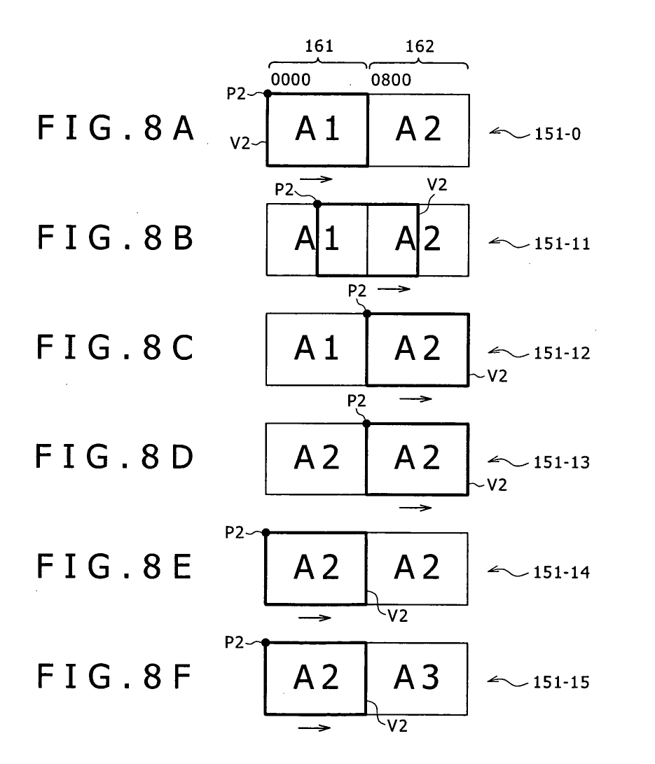

Push-in displaying in the left and right directions executed by the display control unit of FIG. 4 will be described below with reference to FIGS. 7A to 7F and 8A to 8F.

FIGS. 7A to 7F and 8A to 8F illustrate the states of a VRAM map 151 that is the virtual address space in the VRAM 104 for push-in displaying in the left and right directions. The addresses indicated on the upside of the drawing are the actual addresses in the VRAM 104 corresponding to the VRAM map 151. Referring to FIGS. 7A to 7F and 8A to 8F, the VRAM map 151 is composed of a one-screen area 161 and a one-screen area 162 that are laterally arranged in that order from the left of the VRAM map 151. The one-screen area 161 is the area from address 0000 to address 07FF, and the one-screen area 162 is the area from address 0800 to address 0FFF.

Note that the branch numbers of the reference numerals of a VRAM map 151-0 of FIG. 7A, VRAM maps 151-1 to 151-5 of FIGS. 7B to 7F, a VRAM map 151-0 of FIG. 8A and VRAM maps 151-11 to 151-15 of FIGS. 8B to 8F indicate the order of the processing. Indicated for each VRAM map 151 are a display area V2 and a display beginning position P2 at the time of the corresponding processing. The arrow under the display area V2 indicates the movement direction of the display beginning position P2.

Initially, push-in displaying with its effect direction being the right direction will be described with reference to FIGS. 7A to 7F.

The memory controller 103 retrieves from the buffer 23 the image data of the image A1 and an image A2 and develops the image data of the images A1 and A2 in the areas 161 and 162, respectively, as shown in the VRAM map 151-0 of FIG. 7A. Under control by the display controller 101, the address generator 102 instructs the memory controller 103 to move the display beginning position P2 to address 0000 (the beginning address of the area 161).

The memory controller 103 moves the display beginning position P2 to address 0000 in the VRAM 104. The memory controller 103 then retrieves the image data in the display area V2 starting from address 0000 (the image data of the image A1 developed in the area 161) and supplies the image data to the display unit 28 via the driver 105. Thus, the display unit 28 displays the image A1 corresponding to the image data developed in the area 161.

Upon the displaying of the image A1, which is an entire one image, the display controller 101 determines which of the left and right directions is to be employed as the movement direction of the display beginning position P2, while keeping on the displaying of the image A1 for a certain period (e.g., three seconds). Since the effect direction is the right direction in the example of FIGS. 7A to 7F, the display controller 101 determines to use the left direction as the movement direction of the display beginning position P2. Subsequently, the display controller 101 determines whether or not a one-screen area in which an image to be displayed next has been developed exists in the destination in the movement direction of the display beginning position P2 (i.e., in the left direction).

In the example of FIG. 7A, a one-screen area in which an image to be displayed next has been developed is absent in the destination on the left of the area 161 in the VRAM map 151-0. Therefore, the display controller 101 controls the address generator 102 and the memory controller 103 so that the image data of the currently displayed image A1 is duplicated in the area 162, which is on the opposite side of the movement destination of the display beginning position P2, as shown in the VRAM map 151-1 of FIG. 7B.

After the memory controller 103 duplicates and records in the area 162 in the VRAM 104 (the VRAM map 151-1 of FIG. 7B) the image data of the image A1 developed in the area 161, the display controller 101 controls the address generator 102 so that the display beginning position P2, which has been located on the beginning address of the area 161 (address 0000), is moved to the beginning address of the area 162 (address 0800) as shown in the VRAM map 151-2 of FIG. 7C.

Specifically, with referring to the address conversion table, the address generator 102 generates the beginning address of the area 162 (address 0800) and supplies address 0800 to the memory controller 103. The memory controller 103 moves the display beginning position P2 to address 0800 in the VRAM 104, supplied from the address generator 102. The memory controller 103 then retrieves the image data in the display area V2 starting from address 0800 (i.e., the image data of the image A1 developed in the area 162) and supplies the image data to the display unit 28 via the driver 105.

Thus, the display unit 28 displays the image A1 corresponding to the image data developed in the area 162. Since the same image A1 is successively displayed, a user viewing the display unit 28 does not recognize that the duplicated image A1 replaces the previous image A1.

The display controller 101 then controls the address generator 102 and the memory controller 103 so that the image data of a randomly selected image A9 is retrieved from the buffer 23, followed by being developed in the area 161 outside the display area V2 as shown in the VRAM map 151-3 of FIG. 7D. Subsequently, the display controller 101 controls the address generator 102 so that, as shown in the VRAM map 151-4 of FIG. 7E, the display beginning position P2 is sequentially moved in the left direction in the drawing across the movement leg from the beginning address of the area 162 (address 0800) to the beginning address of the area 161 (address 0000) during certain movement time.

Specifically, the address generator 102 generates addresses and supplies the generated addresses to the memory controller 103 sequentially with referring to the address conversion table so that the display beginning position P2 is sequentially moved across the movement leg from address 0800 to address 0000 during certain movement time.

The memory controller 103 sequentially moves the display beginning position P2 and the display area V2 in the range from address 0800 to address 0000 in the VRAM 104 based on the addresses supplied from the address generator 102. Furthermore, after each movement, the memory controller 103 retrieves the image data in the display area V2 starting from the display beginning position P2 and supplies the image data to the display unit 28 via the driver 105.

Thus, the display unit 28 sequentially displays the images corresponding to the image data included in the display area V2. Initially, the percentage of image data of the image A1 is large in the entire image data included in the display area V2. However, since the display beginning position P2 sequentially moves in the left direction, the percentage of image data of the image A9 increases every time the image data in the display area V2 is sequentially retrieved. Specifically, the sequential movement of the display beginning position P2 in the range from address 0800 to address 0000 allows the display unit 28 to display the images as if the image A1 was pushed out by the image A9 in the right direction in the drawing, which achieves push-in displaying in the right direction.

The processing of thus sequentially moving the display beginning position P2 and the display area V2 in the range from address 0800 to address 0000 is repeated until address 0000 is specified as the display beginning position P2. Eventually, according to an instruction from the address generator 102, the memory controller 103 moves the display beginning position P2 to address 0000 (the beginning address of the area 161), as shown in the VRAM map 151-5 of FIG. 7F. The memory controller 103 then retrieves the image data in the display area V2 starting from address 0000 of the VRAM 104 (i.e., the image data of the image A9 developed in the area 161) and supplies the image data to the display unit 28 via the driver 105.

Thus, the display unit 28 displays the image A9 corresponding to the image data developed in the area 161.

At this time, address 0000 specified as the display beginning position P2 is the beginning address of the area 161, and therefore the movement time indicated to the address generator 102 has elapsed. Consequently, the display controller 101 determines which of the left and right directions is to be employed as the next movement direction of the display beginning position P2. Since the effect direction is the right direction in the example of FIGS. 7A to 7F, the display controller 101 determines to use the left direction as the movement direction of the display beginning position P2. Subsequently, the display controller 101 determines whether or not a one-screen area in which an image to be displayed next has been developed exists in the destination in the movement direction of the display beginning position P2 (i.e., in the left direction).

In the example of FIG. 7F, as with the VRAM map 151-0 of FIG. 7A, a one-screen area in which an image to be displayed next has been developed is absent in the destination on the left of the area 161 in the VRAM map 151-5. Therefore, the display controller 101 controls the address generator 102 and the memory controller 103 so that the image data of the currently displayed image A9 is duplicated in the area 162, which is on the opposite side of the movement destination of the display beginning position P2. After this duplication, the similar processing to that subsequent to the processing indicated with the VRAM map 151-1 of FIG. 7A is repeated, with developed and displayed images being replaced by other images.

As described above, push-in displaying with its effect direction being the right direction is successively executed.

Push-in displaying with its effect direction being the left direction will be described with reference to FIGS. 8A to 8F. Note that detailed description of the same processing in FIG. 8A to 8F as that in FIG. 7A to 7F will be adequately omitted in order to avoid redundant repetition.

The memory controller 103 retrieves from the buffer 23 the image data of the images A1 and A2 and develops the image data of the images A1 and A2 in the areas 161 and 162, respectively, as shown in the VRAM map 151-0 of FIG. 8A. Under control by the display controller 101, the address generator 102 instructs the memory controller 103 to move the display beginning position P2 to address 0000 (the beginning address of the area 161).

The memory controller 103 moves the display beginning position P2 to address 0000 of the VRAM 104. The memory controller 103 then retrieves the image data in the display area V2 starting from address 0000 (the image data of the image A1 developed in the area 161) and supplies the image data to the display unit 28 via the driver 105. Thus, the display unit 28 displays the image A1 corresponding to the image data developed in the area 161.

Upon the displaying of the image A1, which is an entire one image, the display controller 101 determines which of the left and right directions is to be employed as the movement direction of the display beginning position P2, while keeping on the displaying of the image A1 for a certain period (e.g., three seconds). Since the effect direction is the left direction in the example of FIGS. 8A to 8F, the display controller 101 determines to use the right direction as the movement direction of the display beginning position P2. Subsequently, the display controller 101 determines whether or not a one-screen area in which an image to be displayed next has been developed exists in the destination in the movement direction of the display beginning position P2 (i.e., in the right direction).

In the example of FIG. 8A, the one-screen area 162, in which the image to be displayed next has been developed, is present in the destination on the right of the area 161 in the VRAM map 151-0. Therefore, the display controller 101 controls the address generator 102 so that, as shown in the VRAM map 151-11 of FIG. 8B, the display beginning position P2 is sequentially moved in the right direction in the drawing across the movement leg from the beginning address of the area 161 (address 0000) to the beginning address of the area 162 (address 0800) during certain movement time.

Specifically, the address generator 102 generates addresses and supplies the generated addresses to the memory controller 103 sequentially with referring to the address conversion table so that the display beginning position P2 is sequentially moved across the movement leg from address 0000 to address 0800 during certain movement time.

The memory controller 103 sequentially moves the display beginning position P2 and the display area V2 in the right direction in the drawing in the range from address 0000 to address 0800 in the VRAM 104 based on the addresses supplied from the address generator 102. Furthermore, after each movement, the memory controller 103 retrieves the image data in the display area V2 starting from the display beginning position P2 and supplies the image data to the display unit 28 via the driver 105.

Thus, the display unit 28 sequentially displays the images corresponding to the image data included in the display area V2. Initially, the percentage of image data of the image A1 is large in the entire image data included in the display area V2. However, since the display beginning position P2 sequentially moves in the right direction, the percentage of image data of the image A2 increases every time the image data in the display area V2 is sequentially retrieved. Specifically, the sequential movement of the display beginning position P2 in the range from address 0000 to address 0800 allows the display unit 28 to display the images as if the image A1 was pushed out by the image A2 in the left direction in the drawing, which achieves push-in displaying in the left direction.

The processing of thus sequentially moving the display beginning position P2 and the display area V2 in the range from address 0000 to address 0800 is repeated until address 0800 is specified as the display beginning position P2. Eventually, according to an instruction from the address generator 102, the memory controller 103 moves the display beginning position P2 to address 0800 (the beginning address of the area 162), as shown in the VRAM map 151-12 of FIG. 8C. The memory controller 103 then retrieves the image data in the display area V2 starting from address 0800 (i.e., the image data of the image A2 developed in the area 162) and supplies the image data to the display unit 28 via the driver 105.

Thus, the display unit 28 displays the image A2 corresponding to the image data developed in the area 162.

At this time, address 0800 specified as the display beginning position P2 is the beginning address of the area 162, and therefore the movement time indicated to the address generator 102 has elapsed. Consequently, the display controller 101 determines which of the left and right directions is to be employed as the next movement direction of the display beginning position P2. Since the effect direction is the left direction in the example of FIGS. 8A to 8F, the display controller 101 determines to use the right direction as the movement direction of the display beginning position P2. Subsequently, the display controller 101 determines whether or not a one-screen area in which an image to be displayed next has been developed exists in the destination in the movement direction of the display beginning position P2 (i.e., in the right direction).

In the example of FIG. 8C, a one-screen area in which an image to be displayed next has been developed is absent in the destination on the right of the area 162 in the VRAM map 151-12. Therefore, the display controller 101 controls the address generator 102 and the memory controller 103 so that the image data of the currently displayed image A2 is duplicated in the area 161, which is on the opposite side of the movement destination of the display beginning position P2, as shown in the VRAM map 151-13 of FIG. 8D.

After the memory controller 103 duplicates and records in the area 161 in the VRAM 104 (the VRAM map 151-13 of FIG. 8D), the image data of the image A2 developed in the area 162, the display controller 101 controls the address generator 102 and the memory controller 103 so that the display beginning position P2, which has been located on the beginning address of the area 162 (address 0800), is moved to the beginning address of the area 161 (address 0000) as shown in the VRAM map 151-14 of FIG. 8E.

Specifically, with referring to the address conversion table, the address generator 102 generates the beginning address of the area 161 (address 0000) and supplies address 0000 to the memory controller 103. The memory controller 103 moves the display beginning position P2 to address 0000 in the VRAM 104, supplied from the address generator 102. The memory controller 103 then retrieves the image data in the display area V2 starting from address 0000 (i.e., the image data of the image A2 developed in the area 161) and supplies the image data to the display unit 28 via the driver 105.

Thus, the display unit 28 displays the image A2 corresponding to the image data developed in the area 161. Since the same image A2 is successively displayed, a user viewing the display unit 28 does not recognize that the duplicated image A2 replaces the previous image A2.

The display controller 101 then controls the address generator 102 and the memory controller 103 so that the image data of a randomly selected image A3 is retrieved from the buffer 23, followed by being developed in the area 162 outside the display area V2 as shown in the VRAM map 151-15 of FIG. 8F. Subsequently, the display controller 101 controls the address generator 102 so that the display beginning position P2 is sequentially moved in the right direction in the drawing across the movement leg from the beginning address of the area 161 (address 0000) to the beginning address of the area 162 (address 0800) during certain movement time.

Thus, the display unit 28 sequentially displays the images corresponding to the image data included in the display area V2, and the similar processing to that subsequent to the processing indicated with the VRAM map 151-11 of FIG. 8B is executed, with developed and displayed images being replaced by other images.

As described above, push-in displaying with its effect direction being the left direction is successively executed.

As described above, also in push-in displaying with its effect direction being the left and right directions, the following processing sequence is repeated: when the image data of an image to be displayed next is not developed in the destination in the movement direction of the display beginning position, (a) duplicating the image data of the currently displayed image in the area opposite to the movement destination; (b) moving the display beginning position to the area in which the duplicated image data has been developed; and (c) developing the image data of the image to be displayed next in the destination of the moved display beginning position. Thus, the push-in displaying can be repeated infinitely as long as the VRAM has at least two one-screen areas.

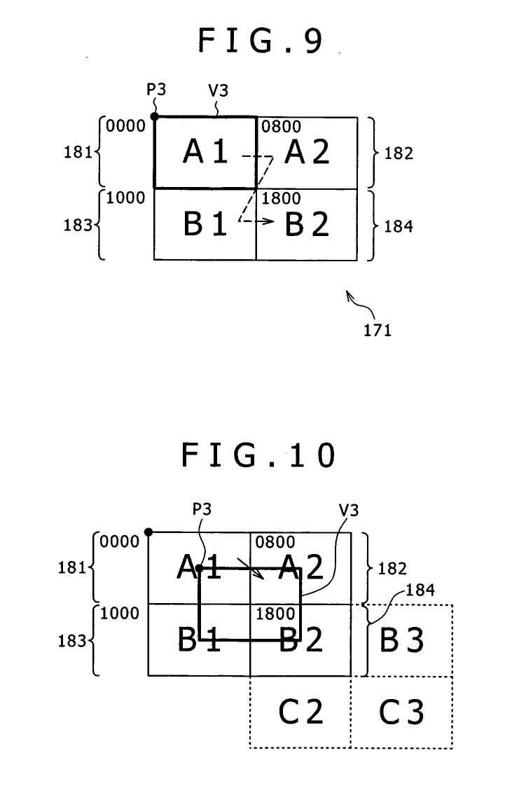

FIG. 9 shows another example of a VRAM map that is the virtual address space of the VRAM 104. The address indicated near each of areas 181 to 184 in the drawing is the actual address in the VRAM 104 corresponding to the beginning address (indicated on the upper left of each area) of the areas 181 to 184 in a VRAM map 171. Indicated for the VRAM map 171 are a display beginning position P3 and a display area V3.

Referring to FIG. 9, the VRAM map 171 is composed of four one-screen areas 181 to 184 in two rows by two columns. The upper row of the VRAM map 171 is composed of the one-screen area 181 and the one-screen area 182 that are laterally arranged. The one-screen area 181 is the area from address 0000 to address 07FF, and the one-screen area 182 is the area from address 0800 to address 0FFF. The lower row of the VRAM map 171 is composed of the one-screen area 183 and the one-screen area 184 that are laterally arranged. The one-screen area 183 is the area from address 1000 to address 17FF, and the one-screen area 184 is the area from address 1800 to address 1FFF.

That is, in the actual VRAM 104, the areas are disposed in the order of the areas 181, 182, 183 and 184 as indicated by the dotted arrow.

When in the VRAM map 171 of FIG. 9, the areas 181 and 182 are used and the display beginning position P3 is moved in the right direction in the range from the beginning address of the area 181 to that of the area 182 (i.e., from address 0000 to address 0800 in the VRAM 104), the display unit 28 implements push-in displaying in the left direction in which the images A1 and A2 are successively displayed as if the image A1 was pushed out by the image A2 in the left direction in the drawing, as described above with reference to FIGS. 8A to 8F. It should be obvious that push-in displaying in the right direction described above with reference to FIGS. 7A to 7F can also be achieved similarly.

In addition, when in the VRAM map 171, the areas 181 and 183 are used and the display beginning position P3 is moved in the downward direction in the range from the beginning address of the area 181 to that of the area 183, the display unit 28 implements push-in displaying in the upward direction in which the images A1 and B1 are successively displayed as if the image A1 was pushed out by the image B1 in the upward direction in the drawing, as described above with reference to FIGS. 5A to 5F. It should be obvious that push-in displaying in the downward direction described above with reference to FIGS. 6A to 6F can also be achieved similarly.

In this case, however, the area 182 (from address 0800 to address 0FFF) is not used as the movement leg. Therefore, the address generator 102 generates addresses with taking into consideration addresses from 0800 to 0FFF in the VRAM 104 actually.

In thus carrying out push-in displaying in the vertical directions and lateral directions, using the VRAM map 171 of FIG. 9 can allow share of the area 181 in the VRAM map 171, which can reduce the number of areas in the VRAM 104.

Moreover, even when addresses that are not used as the movement leg exist like the vertical push-in in the VRAM map 171 of FIG. 9, the addresses can easily be generated since the addresses can be obtained as a one-screen area in advance.

It should be obvious that using at least the areas 181 to 183 and combining the vertical push-in displaying with the lateral push-in displaying allow random push-in displaying in the vertical and lateral directions.

In addition, in the VRAM map 171, by using all the areas 181 to 184 and moving the display beginning position P3 in the range from the beginning address of the area 181 to that of the area 184, as shown in FIG. 10, push-in displaying in an oblique direction is also allowed in which movement is implemented so that the effect direction is from the upper right to the lower left (or conversely from the lower left to the upper right), or from the upper right to the lower left (or conversely from the lower left to the upper right) in the drawing.

More specific description will be made by taking as an example the case in which, as indicated by the arrow in FIG. 10, the movement direction of the display beginning position P3 is from the upper left to the lower right (i.e., the effect direction is from the lower right to the upper left), assuming that initially the display beginning position P3 is located on the beginning address of the area 184 (address 1800), and thus the display unit 28 displays the image B2 corresponding to the image data developed in the area 184.

As indicated by the dashed lines in FIG. 10, the images to be displayed next on the right of the image B2, below the B2, and on the lower right of the image B2 are images B3, C2 and C3, respectively. The display controller 101 determines that three one-screen areas in which the image data of the images to be displayed next has been developed are absent in the destination and the path to the destination in the movement direction of the display beginning position P3. The display controller 101 then controls the address generator 102 and the memory controller 103 so that the image data of the currently displayed image B2 is duplicated and recorded in the area 181, which is on the opposite side of the movement destination of the display beginning position P3.

Subsequently, the display controller 101 controls the address generator 102 so that the display beginning position P3, which has been located at the beginning address of the area 184 (address 1800), is moved to the beginning address of the area 181 (address 0000). Thus, the display unit 28 displays the image B2 corresponding to the image data developed in the area 181.

The display controller 101 then controls the address generator 102 and the memory controller 103 so that the image data of the randomly selected images B3, C2 and C3 is retrieved from the buffer 23, followed by being developed in the areas 182, 183 and 184, respectively. Subsequently, the display controller 101 controls the address generator 102 so that the display beginning position P3 is sequentially moved in the direction from the upper left to the lower right in FIG. 10 across the movement leg from the beginning address of the area 181 (address 0000) to the beginning address of the area 184 (address 1800) during certain movement time.

Thus, the display unit 28 sequentially displays the images corresponding to the image data included in the display area V3. Specifically, the display unit 28 implements push-in displaying in an oblique direction in which the images are displayed as if the image B2 was pushed out by the images B3, C2 and C3 in the direction from the lower right to the upper left in FIG. 10, and eventually only the image C3 is displayed.

In this case, the areas 182 and 183 (from address 0800 to address 1FFF) are not used as the movement leg. Therefore, the address generator 102 generates addresses with taking into consideration addresses from 0800 to 17FF in the VRAM 104 actually.

As described above, also in push-in displaying with its effect direction being an oblique direction, the following processing sequence is repeated: when the image data of images to be displayed next is not developed in the destination and the path in the movement direction of the display beginning position, (a) duplicating the image data of the currently displayed image in the area opposite to the movement destination; (b) moving the display beginning position to the area in which the duplicated image data has been developed; and (c) developing the image data of the images to be displayed next in the destination and the path of the moved display beginning position. Thus, the push-in displaying in an oblique direction can be repeated infinitely as long as the VRAM has at least four one-screen areas.

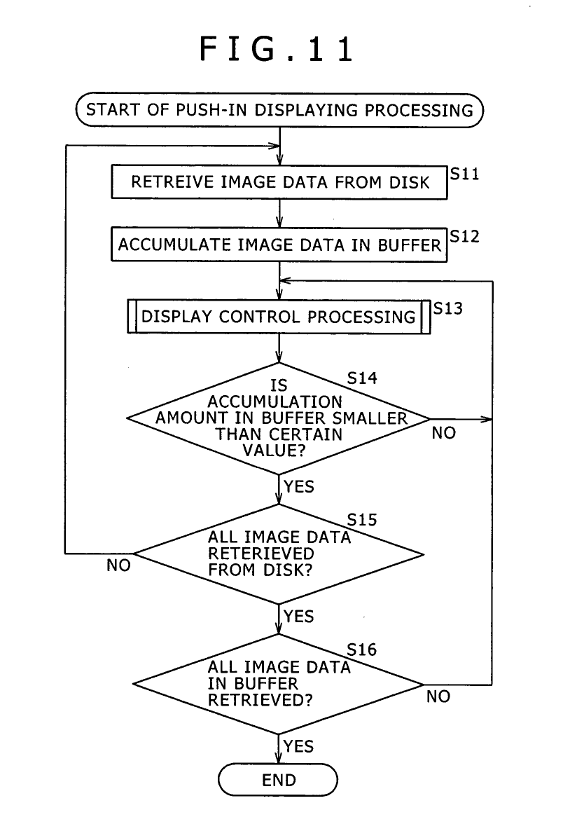

The sequence of push-in displaying processing in the recording and reproducing device 1 of FIG. 3 will be described below with reference to the flowchart of FIG. 11.

A user operates the operation unit 42 to thereby instruct the recording and reproducing device 1 to carry out push-in displaying of images recorded in a certain folder in the disk 60. The operation unit 42 accepts the instruction from the user to the recording and reproducing device 1, and supplies an operation signal indicating the instruction to the main CPU 41.

In a step S11, the main CPU 41 controls the recording and reproducing unit 48 in response to the operation signal from the operation unit 42 so that the recording and reproducing unit 48 retrieves image data from the disk 60. The main CPU 41 then transmits to the camera CPU 21 via the communication unit 52, the serial bus 71 and the communication unit 26, together with the retrieved image data, a first command for storing the image data in the buffer 23 and a second command for executing push-in displaying of images of the image data.

The image data retrieved at this time is data for thumbnail view, and the image data of sixty images is transmitted simultaneously. Therefore, if the image data of more than sixty images is recorded in the certain folder, the not-yet-transmitted remaining image data is to be transmitted when, in a step S14 to be described later, a determination is made that the amount of the image data accumulated in the buffer 23 becomes smaller than a certain value (e.g., when the number of the image data pieces accumulated in the buffer 23 becomes five).

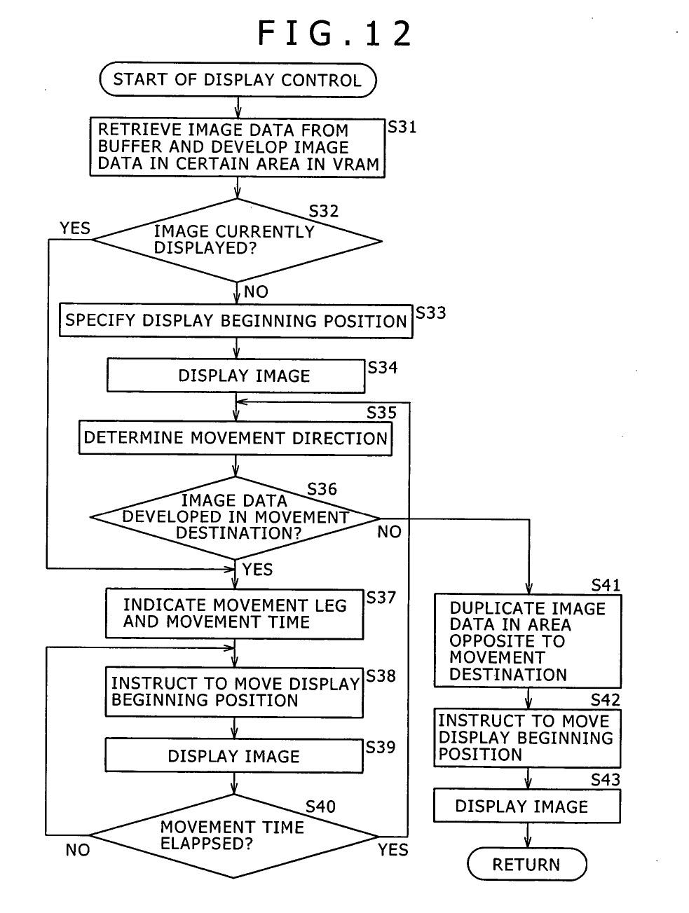

In a step S12, the camera CPU 21 accumulates the image data transmitted from the main CPU 41 in the buffer 23 according to the first command transmitted from the main CPU 41. Subsequently, in a step S13, the camera CPU 21 causes the display controller 101 to execute display control processing for push-in displaying according to the second command. This display control processing will be described below with reference to the flowchart of FIG. 12 and the above-described VRAM map 151 of FIGS. 8A to 8F.

In a step S31, the display controller 101 randomly selects image data among the image data accumulated in the buffer 23, and then controls the address generator 102 and the memory controller 103 so that the selected image data is retrieved from the buffer 23, followed by being developed in certain areas in the VRAM 104. The processing sequence then moves to a step S32. Note that at the start of the processing, the display controller 101 develops image data in all the areas in which image data can be developed. Specifically, in the VRAM map 151 of FIG. 8A to 8F, the image data of the images A1 and A2 is developed in two areas 161 and 162, respectively.

More specifically, the display controller 101 induces the memory controller 103 to retrieve image data (e.g., the image data of the image A1) from the buffer 23, and specifies for the address generator 102, the certain area (e.g., the area 161) in which the memory controller 103 is to develop the image data. The address generator 102 generates the address of the certain area and supplies the generated address to the memory controller 103, with referring to the address conversion table for address conversion between the VRAM map 151 and the address space in the VRAM 104. Under control by the display controller 101, the memory controller 103 retrieves the image data from the buffer 23 and develops (decodes and records) the image data in the address in the VRAM 104 supplied from the address generator 102.

In a step S32, the display controller 101 determines whether or not the display unit 28 displays an image currently. In the present case, since an image is not displayed yet, the display controller 101 determines that an image is not displayed in the step S32, and thus the processing sequence moves to a step S33.

In the step S33, the display controller 101 specifies for the memory controller 103, the display beginning position (e.g., the display beginning position P2) via the address generator 102. That is, the display controller 101 instructs the memory controller 103 to move the display beginning position to the address supplied from the address generator 102. In a step S34, the memory controller 103 retrieves the image data in the display area (e.g., the display area V2), developed in the certain area (e.g., the area 161) in the VRAM 104 based on the address (e.g., address 0000) supplied from the address generator 102. The memory controller 103 then causes, via the driver 105, the display unit 28 to display the image of the retrieve image data, which is then followed by a step S35.

Thus, the image A1, which corresponds to the image data developed in the area 161 in the VRAM map 151-0 of FIG. 8A, is displayed on the display unit 28.

In the step S35, the display controller 101 randomly determines the movement direction of the display beginning position (display area), and subsequently in a step S36, the display controller 101 determines whether or not image data has been developed in the destination in the determined movement direction of the display beginning position. In the VRAM map 151-0 of FIG. 8A, the image data of the image A2 has been developed in the area 162 on the right of the display beginning position P2 (display area V2). Therefore, if the movement direction of the display beginning position has been determined to be the right direction, the positive determination is made in the step S36.

If the display controller 101 determines in the step S36 that image data has been developed in the destination in the determined movement direction of the display beginning position, the processing sequence moves to a step S37. In the step S37, the display controller 101 indicates to the address generator 102 the movement leg and movement time of the display beginning position, which is then followed by a step S38. If the displaying time for an entire one image after push-in emergence is three seconds for example, the display controller 101 sets the movement time as the time period from the moment after the elapse of three seconds after the start of displaying of an entire one image to the moment at the start of displaying of the next entire one image, and then supplies the movement time to the address generator 102. That is, the movement time can also be referred to as the movement period of the display beginning position from one image to the next image.

In the step S38, the address generator 102 instructs to move the display beginning position based on the movement leg and movement time of the display beginning position indicated by the display controller 101, which is then followed by a step S39. Specifically, the address generator 102 determines movement amount and the number of seconds the movement takes, based on the movement leg and movement time. The address generator 102 then generates the address of the display beginning position with referring to the address conversion table, and supplies the generated address to the memory controller 103 at predetermined timing.

In the step S39, based on the address of the display beginning position supplied from the address generator 102, the memory controller 103 retrieves the image data developed in the display area staring from the address. Subsequently, the memory controller 103 supplies the retrieved image data to the display unit 28 via the driver 105, and causes the display unit 28 to display the corresponding image, which is then followed by a step S40.

In the step S40, the display controller 101, which implements time counting operation with a clock (not shown) incorporated therein, determines whether or not the movement time indicated to the address generator 102 in the step S37 has elapsed. If the display controller 101 determines that the movement time has not elapsed yet, the processing sequence returns to the step S38 and the subsequent processing is repeated. That is, until the movement time has elapsed, the moved display beginning positions are sequentially indicated and the images in the display areas starting from the moved display beginning positions are sequentially displayed on the display unit 28.

Thus, as shown in the VRAM map 151-11 of FIG. 8B, the display beginning position P2 is sequentially moved in the right direction. Accordingly, the display unit 28 displays images in such a manner that the image A2 pushes out the image A1 in the left direction, which achieves push-in displaying with its effect direction being the left direction.

If the display controller 101 determines that the movement time has elapsed in the step S40, the processing sequence returns to the step S35 and the subsequent processing is repeated.

Specifically, when the movement time has elapsed, as shown in the VRAM map 151-12 of FIG. 8C, the display beginning position P2 corresponds with the beginning address 0800 of the area 162 in which the image A2 has been developed, and therefore the display unit 28 displays the entire one image (the image A2). Consequently, the display controller 101 randomly determines the next movement direction of the display beginning position in the step S35, and subsequently in the step S36, the display controller 101 determines whether or not image data has been developed in the destination in the determined movement direction of the display beginning position.

Assuming that the movement direction of the display beginning position is determined to be the right direction again, the specific description will be made with reference to the VRAM map 151-12 of FIG. 8C. In the VRAM map 151-12, image data is not developed on the right of the area 162. That is, an area in which image data has been developed does not exist in the movement destination of the display beginning position P2.

In this case, the display controller 101 determines in the step S36 that image data is not developed in the destination in the determined movement direction of the display beginning position, and the processing sequence moves to a step S41. In the step S41, the display controller 101 controls the address generator 102 and the memory controller 103 so that the image data corresponding to the currently displayed image (i.e., the image data developed in the area 162) is duplicated in the area on the opposite side of the movement destination of the display beginning position, which is then followed by a step S42.

Specifically, the display controller 101 specifies for the address generator 102, the area (e.g., the area 161), on the opposite side of the movement destination of the display beginning position P2, in which the image data is to be duplicated by the memory controller 103. The display controller 101 then induces the memory controller 103 to duplicate the image data (e.g., the image data of the image A2). With referring to the address conversion table, the address generator 102 generates the address of the area opposite to the destination, and then supplies the generated address to the memory controller 103. Under control by the display controller 101, the memory controller 103 duplicates and records the image data in the certain area starting from the address supplied from the address generator 102.

Thus, as shown in the VRAM map 151-13 of FIG. 8D, the image data of the image A2 developed in the area 162 is duplicated and recorded in the area 161.

In the step S42, the display controller 101 specifies for the memory controller 103 via the address generator 102, the beginning address of the area 161 as the display beginning position P2 (i.e., instructs the memory controller 103 to move the display beginning position P2 to the beginning address of the area 161), which is then followed by a step S43. In the step S43, based on the address supplied from the address generator 102, the memory controller 103 retrieves the image data developed in the area 161 in the VRAM 104. Subsequently, the memory controller 103 supplies the retrieved image data to the display unit 28 via the driver 105, and causes the display unit 28 to display the corresponding image. Subsequently, the display controller 101 ends the control display processing, and referring again to FIG. 11, the processing sequence moves from the step S13 to the step S14.

Thus, the image A2, which corresponds to the image data developed in the area 161 in the VRAM map 151-14 of FIG. 8E, is displayed on the display unit 28.

In the step S14 of FIG. 11, the camera CPU 21 determines whether or not the amount of the image data accumulated in the buffer 23 is smaller than a certain value. If a determination is made in the step S14 that the amount of the image data accumulated in the buffer 23 is lager than the certain value, i.e., that much image data is accumulated in the buffer 23, the processing sequence returns to the step S13 (the step S31 of FIG. 12) and the subsequent processing is repeated by controlling the display controller 101.

Specifically, in the step S31 of FIG. 12, the display controller 101 randomly selects image data (e.g., the image data of the image A3) among the image data accumulated in the buffer 23, and then controls the address generator 102 and the memory controller 103 so that, as shown in the VRAM map 151-15 of FIG. 8F, the selected image data is retrieved from the buffer 23, followed by being developed in an certain area (e.g., the area 162) in the VRAM 104. The processing sequence then moves to the step S32.

In this case, the display unit 28 has displayed the image A2 corresponding to the image data developed in the area 161 since the step S43. Therefore, in the step S32, the display controller 101 determines that an image is currently displayed. Thus, the processing sequence moves to the step S37 and the subsequent processing is repeated.

In contrast, in the step S14 of FIG. 11, if a determination is made that the amount of the image data accumulated in the buffer 23 is smaller than the certain value, the processing sequence moves to a step S15, in which the camera CPU 21 determines whether or not the main CPU 41 has retrieved all the image data from the certain folder in the disk 60. If all the image data in the certain folder has been retrieved, when transmitting the image data retrieved from the certain folder, the main CPU 41 also transmits an indication of the completion of retrieving of image data, with the indication being included in a command instructing to store the image data.

Thus, if the camera CPU 21 has not been notified of the completion of retrieving of image data by the main CPU 41, the camera CPU 21 determines in the step S15 that the main CPU 41 has not retrieved all the image data from the certain folder in the disk 60. Therefore, the camera CPU 21 requests the main CPU 41 via the communication unit 26, the serial bus 71 and the communication unit 52 to transmit the remaining image data, and the processing sequence returns to the step S11, followed by the subsequent processing.

In contrast, if the camera CPU 21 has been notified of the completion of retrieving of image data by the main CPU 41, the camera CPU 21 determines in the step S15 that the main CPU 41 has retrieved all the image data from the certain folder in the disk 60. Therefore, the processing sequence moves to a step S16, in which the camera CPU 21 determines whether or not all the image data in the buffer 23 has been retrieved.

If the camera CPU 21 determines in the step S16 that all the image data in the buffer 23 has not been retrieved, the processing sequence returns to the step S13 (the step S31 of FIG. 12) and the subsequent processing is repeated by controlling the display controller 101. That is, the display control processing for push-in displaying is repeated until the memory controller 103 has retrieved all the image data accumulated in the buffer 23.

If the camera CPU 21 determines in the step S16 that all the image data in the buffer 23 has been retrieved, the push-in displaying ends.

As described above, when second image data of an image to be displayed next is not developed in the destination in the movement direction of the display beginning position (display area) in a first area in which first image data of the currently displayed image has been developed, the following processing sequence is carried out: (a) duplicating the first image data of the currently displayed image in a second region on the opposite side of the movement destination; (b) moving the display beginning position to the second area including the duplicated first image data; and (c) developing the second image data of the image to be display next in the first area. Therefore, push-in displaying can be carried out easily with simple processing.

In addition, two one-screen areas are enough to achieve the push-in displaying, which can reduce the capacity of the VRAM. Furthermore, it is sufficient that the above-described simple VRAM map is designed, and thus the hardware configuration can be simplified. Accordingly, the size of the recording and reproducing device itself can be decreased.

Moreover, image data retrieved from the disk 60 is temporarily accumulated in the buffer 23. Therefore, even if the transmission rate of image data between the disk 60 and the display unit 28 is slow due to, for example, the serial bus 71 between the camera block 11 and the recording and reproducing block 12, interruption of image data to be displayed can be suppressed, which allows smoothly serial reproduction.

The above description has employed the VRAM map 151 of FIGS. 8A to 8F. However, also when employing the VRAM map 121 of FIGS. 5A to 5F and 6A to 6F, or the VRAM map 171 of FIG. 9, basically the same processing is carried out except that the address conversion table of the address generator 102 is different, and therefore the description thereof will be omitted in order to avoid redundant repetition.

In addition, the present invention is not limited to the above-described push-in displaying but can also be applied to scroll displaying for serially displaying images.

Although the recording and reproducing device 1 has been described above, the present invention can also be applied to any device for reproducing and displaying images corresponding to image data recorded in a recording medium for example. Specifically, it should be obvious that the embodiments of the invention are not limited to recording and reproducing devices but can also be applied to personal computers. In addition, the embodiments of the invention can be applied to cellular phones, PDA (personal digital assistant) apparatuses, and CE (consumer electronics) apparatuses such as AV (audio visual) apparatuses and home electric appliances as long as they have a function of reproducing and displaying images corresponding to image data recorded in a recording medium.

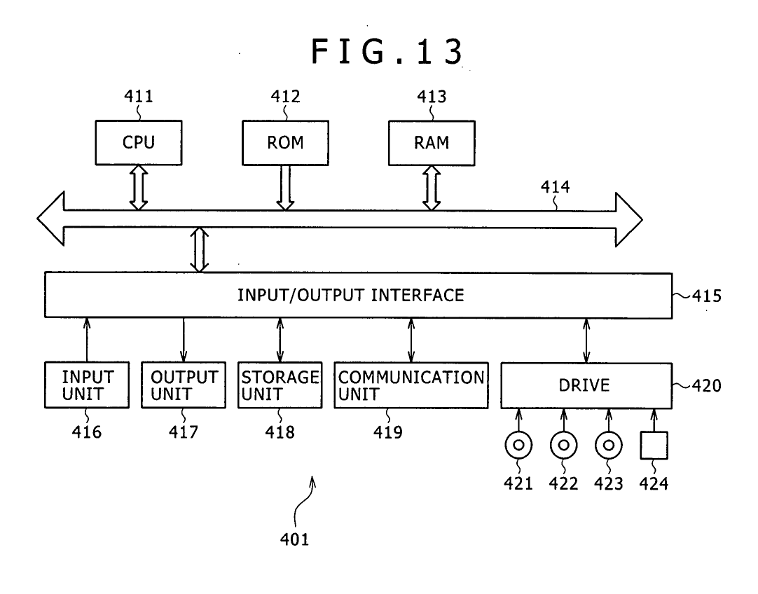

The above-described series of processing can be executed by hardware, or alternatively can also be executed by software. When executing by software, the recording and reproducing device is constructed of a personal computer 401 shown in FIG. 13 for example.

Referring to FIG. 13, a CPU 411 executes various kinds of processing in accordance with a program recorded in a ROM (read only memory) 412 or a program loaded from a storage 418 to a RAM (random access memory) 413. In the RAM 413, data and the like necessary for the execution of various kinds of processing by the CPU 411 are adequately recorded.

For example, the CPU 411 corresponds to the camera CPU 21 of FIG. 3, and the ROM 412, the RAM 413 and the storage 418 correspond to the buffer 23.

The CPU 411, the ROM 412 and the RAM 413 are coupled to each other via a bus 414. An input/output (I/O) interface 415 is also coupled to the bus 414.

Coupled to the I/O interface 415 are an input unit 416, an output unit 417, the storage 418 and a communication unit 419. The input unit 416 includes the imaging unit 22, and the operation unit 42 such as buttons and a mouse. The output unit 417 includes the display unit 28, a speaker and so on. The storage 418 is composed of the buffer 23, a hard disk and so on. The communication unit 419 is composed of a modem, a terminal adapter and so on. The communication unit 419 implements communication processing with another information processing apparatus over a network including the Internet.

Furthermore, a drive 420 is coupled to the I/O interface 415 according to need, and fitted with the drive 420 is a removable recording medium composed of a magnetic disk 421, an optical disk 422, a magnet-optical disk 423, or a semiconductor memory 424. Thus, a computer program retrieved from the recording medium is installed in the storage 418 according to need.

That is, the drive 420 corresponds to the recording and reproducing block 12 of FIG. 3, and the removable recording medium corresponds to the disk 60 of FIG. 3.

When executing a series of processing by software, a program constituting the software is installed from a network or recording medium in a computer incorporating dedicated hardware, or a general-purpose personal computer, in which various programs are installed to thereby allow the computer to execute various functions.

For example, a program constituting software that has a function of the above-described display control unit 24 is installed. It should be noted that there is no particular limitation on the form of the program as long as the program can execute the above-described series of processing as a whole. For example, the program may have a module configuration composed of modules corresponding to the respective above-described blocks. Alternatively, the program may have a module configuration composed of modules that are made up of a combination of part or all of functions of some blocks, or modules having a divided function of a block. Further alternatively, a program having simply one algorithm is also available.

A recording medium including such a program is composed of a removable recording medium (package medium) that is distributed, separately from the device main body, to a user for provision of the program and is made up of the magnetic disk 421 (including a floppy disk), the optical disk 422 (including a CD-ROM (compact disk-read only memory) and a DVD (digital versatile disk)), the magnet-optical disk 423 (including a MD (mini-disk)), or the semiconductor memory 424 recording therein the program. Additively, the recording medium is also composed of the ROM 412 and the storage 418 that are provided to a user after being incorporated in the device main body in advance and record the program therein.

It should be noted that in the present specification, the processing steps that describe a program for causing a computer to execute various kinds of processing do not necessarily need to be implemented time-sequentially in the order of the above-described flowchart but also include processing executed in parallel or individually (for example, parallel processing or processing by an object).

A program may be processed by one computer, or alternatively may be processed by plural computers by distributed processing. Moreover, a program may be transferred to a distant computer and be executed therein.

In the present specification, the term system refers to an entire device composed of plural devices.

It should be understood by those skilled in the art that various modifications, combinations, sub-combinations and alterations may occur depending on design requirements and other factors insofar as they are within the scope of the appended claims or the equivalents thereof.

1. An information processing apparatus for displaying images corresponding to image data recorded in a recording medium, the apparatus comprising:
a range moving unit that moves a display range within areas, on a memory, in which image data retrieved from the recording medium is developed, the display range being a range that includes image data of an image to be displayed;
an image determining unit that determines, upon movement of the display range to a one-screen first area by the range moving unit and displaying of an image corresponding to first image data developed in the first area, whether or not second image data has been developed in a destination in a movement direction of a next movement of the display range;
a duplicating unit that duplicates the first image data in a one-screen second area on an opposite side of the destination in the movement direction of the display range, if the image determining unit determines that the second image data has not been developed in the destination in the movement direction of the display range; and
an image developing unit that develops the second image data in the first area upon movement of the display range by the range moving unit to the second area in which the first image data has been duplicated by the duplicating unit and displaying of an image corresponding to the first image data that has been duplicated in the second area by the duplicating unit.

2. The information processing apparatus according to claim 1, wherein
the range moving unit sequentially moves the display range from the second area to the first area in which the second image data has been developed by the image developing unit.

3. The information processing apparatus according to claim 1, wherein
the range moving unit sequentially moves the display range from the first area to an area in which the second image data has been developed, if the image determining unit determines that the second image data has been developed in the destination in the movement direction of the display range.

4. The information processing apparatus according to claim 1, further comprising
a movement direction setting unit that randomly sets the movement direction of the next movement of the display range.

5. The information processing apparatus according to claim 1, further comprising:
a retrieving unit that retrieves image data from the recording medium; and
an accumulating unit that accumulates in a buffer the image data retrieved by the retrieving unit; wherein
the image developing unit develops in one-screen areas in the memory the image data accumulated in the buffer by the accumulating unit.

6. An information processing method of an information processing apparatus for displaying images corresponding to image data recorded in a recording medium, the method comprising the steps of:
moving a display range within areas, on a memory, in which image data retrieved from the recording medium is developed, the display range being a range that includes image data of an image to be displayed;
determining, when the display range is moved to a one-screen first area due to processing of the moving and an image corresponding to first image data developed in the first area is displayed, whether or not second image data has been developed in a destination in a movement direction of a next movement of the display range;
duplicating the first image data in a one-screen second area on an opposite side of the destination in the movement direction of the display range, if processing of the determining results in a determination that the second image data has not been developed in the destination in the movement direction of the display range; and
developing the second image data in the first area when the display range is moved, due to processing of the moving, to the second area in which the first image data has been duplicated due to processing of the duplicating and an image corresponding to the first image data that has been duplicated in the second area due to processing of the duplicating is displayed.

7. A recording medium that records therein a program for causing a computer to execute processing of displaying images corresponding to image data recorded in a recording medium, the program comprising the steps of:
moving a display range within areas, on a memory, in which image data retrieved from the recording medium is developed, the display range being a range that includes image data of an image to be displayed;
determining, when the display range is moved to a one-screen first area due to processing of the moving and an image corresponding to first image data developed in the first area is displayed, whether or not second image data has been developed in a destination in a movement direction of a next movement of the display range;
duplicating the first image data in a one-screen second area on an opposite side of the destination in the movement direction of the display range, if processing of the determining results in a determination that the second image data has not been developed in the destination in the movement direction of the display range; and
developing the second image data in the first area when the display range is moved, due to processing of the moving, to the second area in which the first image data has been duplicated due to processing of the duplicating and an image corresponding to the first image data that has been duplicated in the second area due to processing of the duplicating is displayed.

8. A program for causing a computer to execute processing of displaying images corresponding to image data recorded in a recording medium, the program comprising the steps of:
moving a display range within areas, on a memory, in which image data retrieved from the recording medium is developed, the display range being a range that includes image data of an image to be displayed;
determining, when the display range is moved to a one-screen first area due to processing of the moving and an image corresponding to first image data developed in the first area is displayed, whether or not second image data has been developed in a destination in a movement direction of a next movement of the display range;
duplicating the first image data in a one-screen second area on an opposite side of the destination in the movement direction of the display range, if processing of the determining results in a determination that the second image data has not been developed in the destination in the movement direction of the display range; and
developing the second image data in the first area when the display range is moved, due to processing of the moving, to the second area in which the first image data has been duplicated due to processing of the duplicating and an image corresponding to the first image data that has been duplicated in the second area due to processing of the duplicating is displayed.
